(19) United States
(12) Patent Application Publication
(10) Pub. No.: US 2007/0177474 A1
(43) Pub. Date: Aug. 2, 2007

(54) Method and apparatus for detecting blank region of optical storage medium

(75) Inventors: Chien-Ming Chen, Hsin-Chu City (TW); Ching-San Wu, Hsin-Chu City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: MediaTek Inc.

(21) Appl. No.: 11/731,559

(22) Filed: Mar. 29, 2007

Related U.S. Application Data
(63) Continuation-in-part of application No. 10/453,628, filed on Jun. 4, 2003.

(51) Int. Cl. G11B 20/18; G11B 15/04

(52) U.S. Cl. 369/53.24; 369/124.11

(57) ABSTRACT

The invention provides a detecting method for effectively detecting blank regions on an optical storage medium. The detecting method is to detect the radio frequency (RF) waveform from the optical storage medium. The RF waveform includes a plurality of sinewaves with different frequencies. The amplitudes of the sinewaves are selectively boosted with different boost gains depending on the frequencies of the sinewaves to obtain a corresponding gain boost signal. The gain boost signal is judged with a predetermined blank judging interval or a predetermined threshold. When the present amplitudes of the gain boost signal fall within the blank judgment interval or are not beyond the predetermined threshold, the RF waveform is deemed detected from the blank regions of the optical storage medium.

This is a continuation-in-part of application Ser. No. 10/453,628 filed Jun. 4, 2003, now pending.

### BACKGROUND OF THE INVENTION

1. Field of the Invention

This invention relates to a detection apparatus and a method for detecting blank regions which have not yet recorded data on an optical storage medium.

2. Description of the Prior Art

While recording data onto an optical storage medium by a driving device of optical storage mediums, it is necessary to be able to discriminate the blank regions which have not yet recorded data thereon from the data recording regions which have recorded data thereon, so as to easily control the relative activities of each component in the driving device and determine regions for recording. The prior art usually utilizes the peak/bottom detection method or slicing level detection method to detect blank regions on an optical storage medium.

Referring to FIG. 1, FIG. 1 is a schematic diagram of a driving device 01 recording/reproducing data on an optical storage medium 14. The driving device 01 comprises a light generator 10 and a sensing module 16. According to the prior art, when the peak/bottom detection method is used to detect blank regions of the optical storage medium 14, the light generator 10 generates a laser beam 12 irradiating to the optical storage medium 14. Afterward, the sensing module 16 receives the laser beam 12 reflected from the optical storage medium 14 and then transforms the reflected laser beam 12 into an electronical signal 18 to be transmitted forward to a detection device 20. The electronical signal 18, which is transformed from the reflected laser beam 12, is generally called radio frequency (RF) signal.

Referring to FIG. 2 and FIG. 3, FIG. 2 is a block diagram of the detection apparatus 20 shown in FIG. 1. FIG. 3 is a schematic diagram of detecting an RF waveform 08 by the peak/bottom detection method according to the prior art. In the detection apparatus 20, a peak/bottom detection circuit 02 is used to detect the amplitude of the electronical signal 18, and the electronical signal 18 is the RF waveform as shown in FIG. 3. The peak/bottom detection circuit 02 utilizes a sampling clock 04 to sample the amplitude of the RF. Then during every time unit, a pre-set threshold value 22 is used as a reference base and a comparator 06 is used to compare the sampled amplitude with the reference base to see whether the sampled amplitude is under or below the pre-set threshold value 22. The RF is deemed to be from the blank regions of the optical storage medium which have not yet recorded data thereon, if the amplitude is below the pre-set threshold value 22, otherwise the RF is deemed to be from the data recording regions which have recorded data thereon.

However, it takes time for sampling, and judgment delay may happen because of time lag. When the detection is from a blank region into a data recording region, the signal is actually in the data recording region. Since the next sampling time is not yet coming, the amplitude information is therefore not yet updated. In such situation, the comparator 06 still uses the former amplitude information to compare with the pre-set threshold value 22. Hence the detection apparatus 20 will judge that the optical storage medium 14 is still in a blank region, resulting in a misjudgment.

FIG. 4 is a block diagram of an alternative detection apparatus 48 in the driving device 01 shown in FIG. 1. FIG. 5 is a schematic diagram of detecting the RF waveform 08 by the slicing level detecting method according to the prior art. The prior art slicing level detecting method can avoid delays of judgment resulted from time lag of sampling as mentioned above. As shown in FIG. 1 and FIG. 4, the laser beam 12 is transformed to be the electronical signal 18 (not shown in FIG. 1) and then transmitted into the detection apparatus 48. In the detection apparatus 48, a waveform detection module 36 is used to detect the RF waveform 08 detected from the optical storage medium 14. Then a predetermined level 30 and a blank judgment interval are selected as a reference base. The upper and lower limits of the blank judgment interval are defined by a positive hysteresis level (PHL) 38 and a negative hysteresis level (NHL) 40. The distances from the PHL 38 to the level 30 and from the NHL 40 to the level 30 are the same. A blank region judgment module 42 is used to judge that whether the waveform 08 is between NHL 40 and PHL 38, i.e., within the blank judgment interval. If yes, it means the RF detected by the waveform detection module 36 is from the blank regions, otherwise it means the RF detected by the waveform detection module 36 is from the data recording regions.

However, the RF waveform potentially comprises background noises 44 and a plurality of different frequency sinewaves 46, wherein the higher the frequency sinewave is, the smaller the amplitude is. If the distances of the level 30 to the PHL 38 and the NHL 40 are defined too narrow, the background noises 44 are easily misjudged as the RF from the data recording regions. If the distances of the level 30 to the PHL 38 and to the NHL 40 are defined too spacious, many RF from data recording regions are easily misjudged as the RF from the blank judgment interval, because their amplitudes of sinewave 46 are not enough and fall into the blank judgment interval.

On the other hand, in Japan Patent No. P2000-293941A, Yamaguchi also discloses an apparatus for detecting blank regions of an optical storage medium. Referring to FIG. 6, FIG. 6 is a schematic diagram of detecting the RF waveform 08 by Yamaguchi. Yamaguchi utilizes an envelope detection unit (not shown) to detect the envelope EV of the RF signal, and then utilizes a comparator (not shown) to compare the envelope EV of the RF signal with a threshold voltage Vth, so as to determine a judgment signal 47 as shown in FIG. 6. In Yamaguchi, if the amplitude of the RF signal is smaller than the threshold voltage Vth (as the waveform 49 shown in FIG. 6), it will not be detected by the envelope detection unit 51, and the blank region or the data recording region will be misjudged.

Therefore, the main scope of the invention is to provide a method and an apparatus to solve these problems as mentioned above.

### SUMMARY OF THE INVENTION

A scope of the invention is to provide a detection apparatus and method thereof for detecting blank regions which have not yet recorded data on an optical storage medium.

The optical storage medium contains data recording regions and blank regions. The data recording regions have recorded a plurality of data thereon, and the blank regions are regions have not yet recorded data thereon. The detection apparatus comprises a waveform detection module for detecting an RF waveform from the optical storage medium. The RF waveform potentially comprises background noises and a plurality of different frequency sinewaves, wherein the higher the frequency sinewave is, the smaller the amplitude is. The detection apparatus also comprises a selective gain boost module for selectively boosting the amplitudes of the sinewaves with different boost gains according to the respective frequencies of the input sinewaves in the RF waveform, and obtaining a corresponding gain boost signal.

According to a preferred embodiment, the detection apparatus comprises a blank region judgment module for judging the gain boost signal with a predetermined blank judgment interval. When the present amplitudes of the gain boost signal fall within the blank judgment interval, the RF waveform detected by the waveform detection module is deemed from the blank regions, otherwise the RF waveform detected by the waveform detection module is deemed from the data recording regions.

According to another preferred embodiment, the detection apparatus comprises a blank region judgment module for judging the gain boost signal with a predetermined threshold. When the present amplitudes of the gain boost signal is not beyond the predetermined threshold, the RF waveform detected by the waveform detection module is deemed from the blank regions, otherwise the RF waveform detected by the waveform detection module is deemed from the data recording regions.

The detection apparatus of the invention can precisely detect the blank region which have not yet recorded data on an optical storage medium and further reduce potential misjudgment.

These and other objective of the invention will no doubt become obvious to those of ordinary skill in the art after reproducing the following detailed description of the preferred embodiment which is illustrated in the various figures and drawings.

### BRIEF DESCRIPTION OF THE APPENDED DRAWINGS

FIG. 1 is a schematic diagram of a prior art driving device of optical storage medium, which is recording and reproducing data from an optical storage medium.

FIG. 2 is a block diagram of the detection apparatus as FIG. 1 shows.

FIG. 3 is a schematic diagram of prior art peak/bottom detection method to detect the RF waveforms.

FIG. 4 is a block diagram of a detection apparatus for another implementation example of the driving device of optical storage medium.

FIG. 5 is a schematic diagram of the prior art slicing level detecting method to detect the RF waveforms.

FIG. 6 is a schematic diagram of detecting the RF waveform by Yamaguchi.

FIG. 7 is a block diagram of the detection apparatus according to one embodiment.

FIG. 8 is a block diagram of a detection apparatus 51 according to one embodiment.

FIG. 9 is a signal relationship diagram for the detection apparatus to detect blank regions according to a predetermined level.

FIG. 10 is a diagram of the gain boost transfer function according to the invention.

FIG. 11 is a flowchart of the detecting method according to the invention.

FIG. 12 is a block diagram of a detection apparatus according to another preferred embodiment of the invention.

FIG. 13 is a schematic diagram of the signals when the detection apparatus utilizing a predetermined threshold to detect blank regions.

FIG. 14 is a flowchart of the detecting method according to the invention.

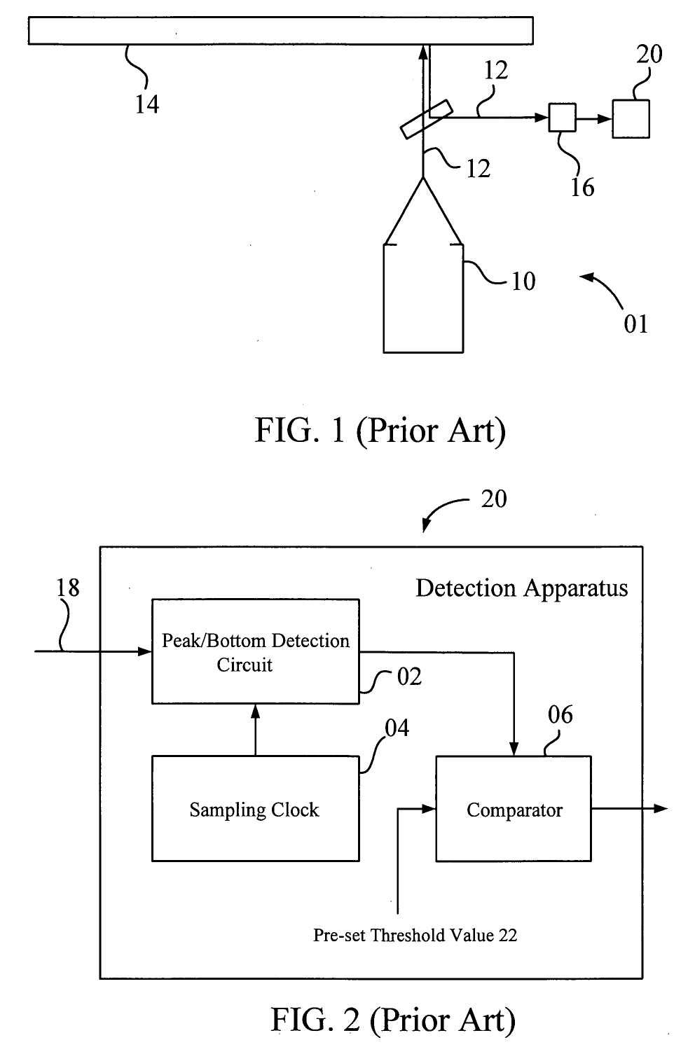

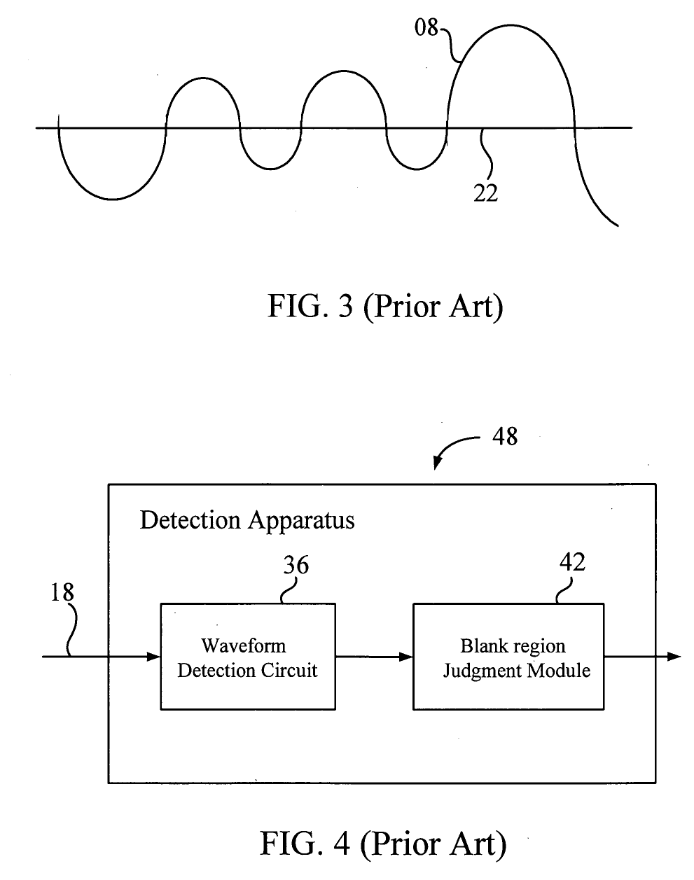

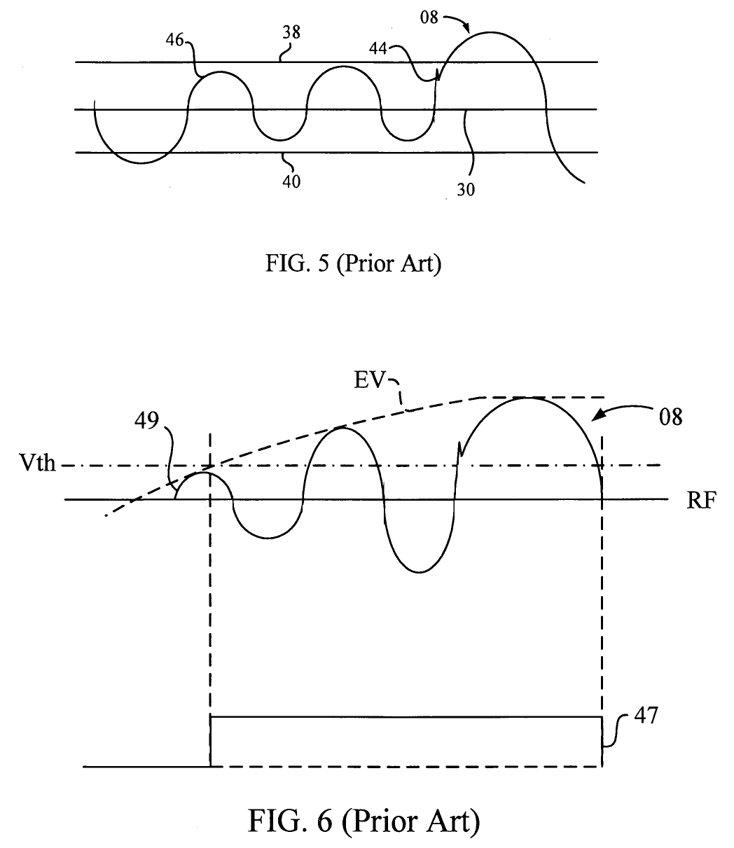

### DETAILED DESCRIPTION OF THE PREFERRED EMBODIMENT

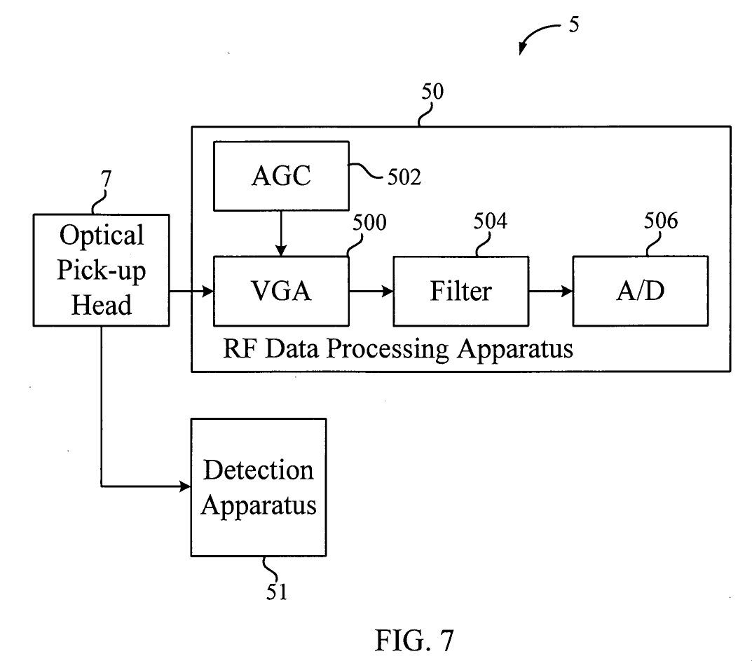

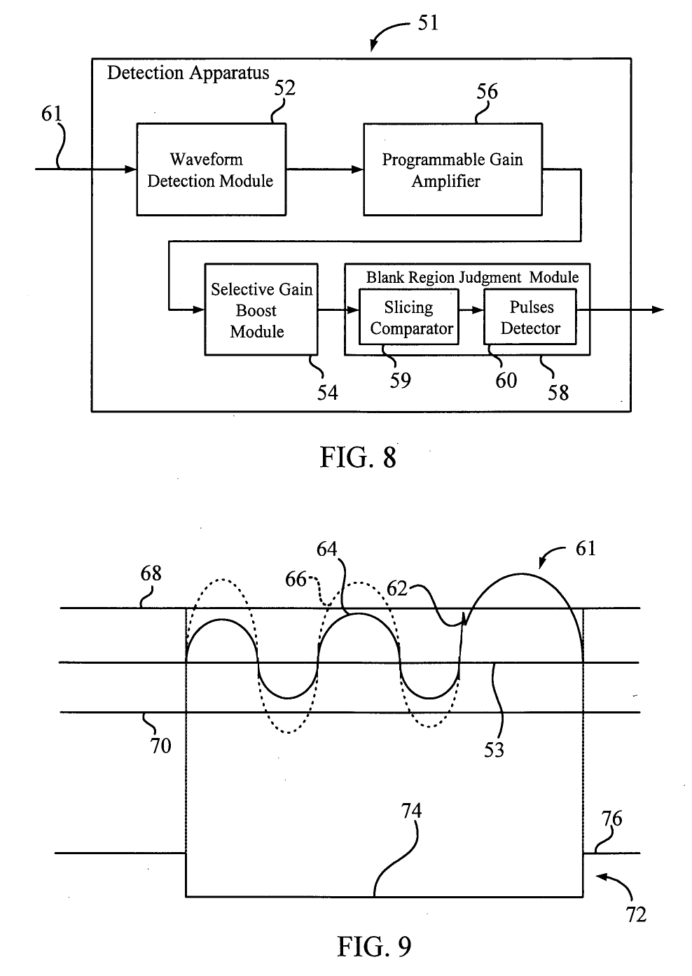

Referring to FIG. 7 through FIG. 9, FIG. 7 is a block diagram of a data processing system 5 according to one embodiment. FIG. 8 is a block diagram of a detection apparatus 51 according to one embodiment. FIG. 9 is a schematic diagram of the signals when the detection apparatus 51 utilizing a predetermined level 53 to detect blank regions. In an optical recording/reproducing apparatus (not shown), the data processing system 5 is used for processing RF data and detecting blank regions on an optical storage medium. As shown in FIG. 7, the data processing system 5 comprises an RF data processing apparatus 50 and a detection apparatus 51. The RF data processing apparatus 50 further comprises a variable gain amplifier (VGA) 500, an auto gain controller (AGC) 502 coupled to the VGA 500, a filter 504, and an analog-to-digital converter 506 for processing RF data detected by an optical pick-up unit 7. When the signal passes through the VGA 500, the VGA 500 will be controlled by the AGC 502 to change its gain dynamically. Since the RF data processing apparatus 50 is well known by one having ordinary skill in the art, it will not be described in detail here.

This embodiment of the invention provides the detection apparatus 51 for detecting blank regions on an optical storage medium. The optical storage medium (not shown) contains data recording regions and blank regions. The data recording regions are regions on the optical storage medium which have recorded a plurality of data thereon. The blank regions are regions on the optical storage medium which have not yet recorded data thereon.

As shown in FIG. 8, the detection apparatus 51 comprises a waveform detection module 52, a programmable gain amplifier 56, a selective gain boost module 54, and a blank region judgment module 58.

The waveform detection module 52 is used for detecting an RF waveform 61 from the optical storage medium. The RF waveform 61 substantially comprises background noises 62 and a plurality of different frequency sinewaves 64. Meanwhile a fact exists that the higher the frequency is, the smaller the amplitude is for any sinewave 64 of RF waveform 61 detected from the optical storage medium. The programmable gain amplifier 56 is used for amplifying the RF waveform 61 detected by the waveform detection module 52 and then for outputting the amplified waveform to the selective gain boost module 54.

The selective gain boost module 54 is used for selectively boosting the amplitudes of the sinewave 64 with different boost gains according to the respective frequencies of the input sinewaves 64 in the RF waveform 61, so as to obtain a corresponding gain boost signal 66. The higher frequency the sinewave 64 is, the bigger gain the amplitude needs. Generally speaking, the gain from the selective gain boost module 54 is substantially from 0 dB to 13 dB.

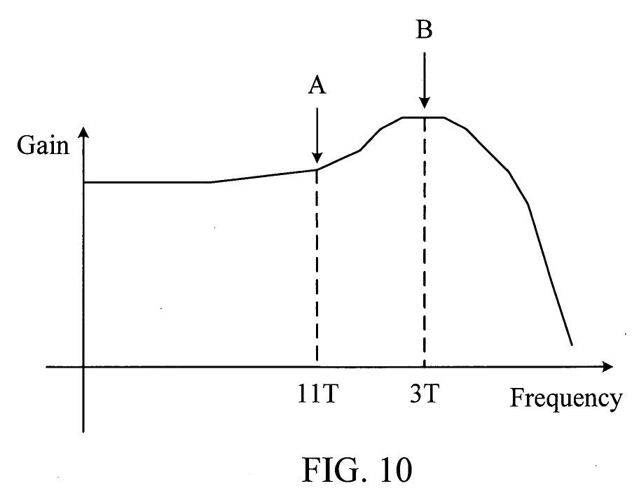

Referring to FIG. 10, FIG. 10 is a diagram of the gain boost transfer function according to the invention. For the characteristic of signals, since the invention utilizes RF waveform to detect the blank regions and the data recording regions, the selective gain boost module 54 shown in FIG. 7 is used for boosting the RF signal. Accordingly, the transfer curve can be obtained by defining the frequency range of RF signal as the following:

i) for CD 1X: 11T˜3T: 196K˜720K;

ii) for CD 52X: 11T˜3T: 10.192M˜37.440M;

iii) for DVD 1X: 14T˜3T: 926K˜4.32M; and

iv) for DVD 16X: 14T˜3T: 14.816M˜69.12M.

The aforesaid definitions of frequency ranges for CD and DVD have already been described in CD and DVD specifications, which are known to one skilled in the art. (Compact Disc Recordable System Description Version 3.1 December 1998 by Philips Electronics, page I-4, and DVD Specifications for Re-recordable Disc Part I Physical Specifications version 1.0 November 1999, page PH1-2).

Due to the characteristic of channel, RF signal with lower frequency, such as 11T, may not decay, but RF signal with higher frequency, such as 3T, may decay. Therefore, the selective gain boost module 54 is used for boosting the RF signal with higher frequency, such as 3T, to compensate the channel for decay and enables the other RF signal with lower frequency, such as 11 T, to pass through. For example, as shown in FIG. 10, the RF signal with lower frequency, such as 11 T (e.g. pole A), will be boosted with the gain equal to 0 dB, and the RF signal with higher frequency, such as 3T (e.g. pole B), will be boosted with the gain equal to 12 dB. In other words, the RF signal with lower frequency will be kept in the original. Accordingly, only when all of the RF signals pass through, the data recording or blank regions can be determined. That is to say, the selective gain boost module 54 of the invention will not suppress the RF signals.

Referring to FIG. 8 and FIG. 9 again, the blank region judgment module 58 is used for judging the gain boost signal 66 according to a predetermined blank judgment interval. The PHL 68 and NHL 70 define the upper and lower limits of the blank judgment interval, respectively. When the present amplitudes of the gain boost signal 66 fall within the blank judgment interval, the RF waveform 61 detected by the waveform detection module 52 is deemed from the blank regions, otherwise the RF waveform 61 detected by the waveform detection module 52 is deemed from the data recording regions. The selective gain boost module 54 will boost the amplitude of the input sinewave 64 of the RF waveform 61 which has higher frequency over the PHL 68 and the NHL 70. When the RF waveform 61 is detected from the data recording region, the RF waveform 61 comprises background noises 62 and a plurality of different frequency sinewaves 64. When the RF waveform 61 is detected from the blank regions, the RF waveform 61 comprises only background noises 62 but no sinewaves 64.

The blank region judgment module 58 will generate a corresponding judgment signal 72, so-called blank flag that is commonly known in the art. The judgment signal 72 comprises a first judgment level 74 and a second judgment level 76. When the amplitude of the gain boost signal 66 is beyond the blank judgment interval, the judgment signal 72 is situated in the first judgment level 74, wherein the first judgment level 74 represents the data recording regions on an optical storage medium. When the amplitude of the gain boost signal 66 is within the blank judgment interval, the judgment signal 72 is situated in the second judgment level 76, wherein the second judgment level 76 represents the blank regions on an optical storage medium.

As shown in FIG. 8, the blank region judgment module 58 comprises a slicing comparator 59 and a pulses detector 60. The slicing comparator 59 is used for setting the blank judgment interval on a predetermined level 53, slicing the gain boost signal 66. The pulses detector 60 will determine whether the judgment signal 72 should be situated in the first judgment level 74 or the second judgment level 76 by the result of the slicing comparator, and determining whether the RF waveform 61 detected by the waveform detection module 52 is from the data recording regions or the blank regions.

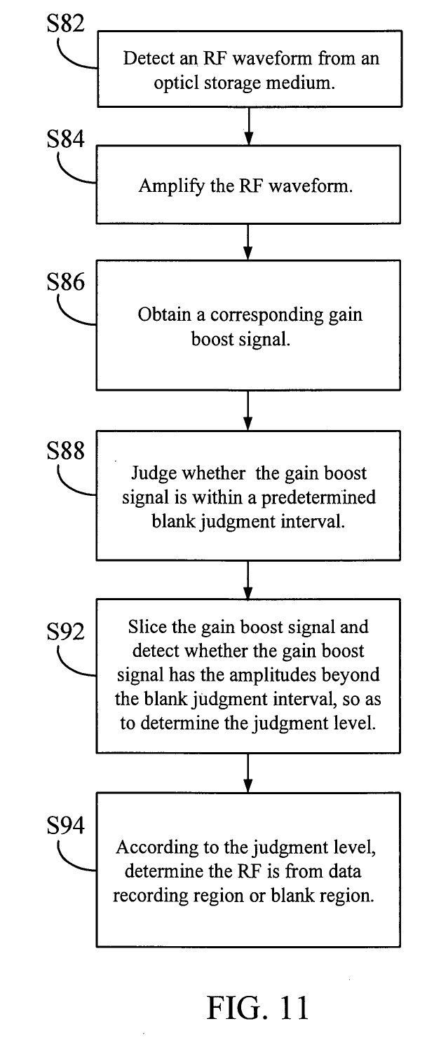

Referring to FIG. 11, FIG. 11 is a flowchart of the detecting method according to the invention. The detecting method of the invention comprises the following steps:

Step S82: detecting the RF waveform 61 from the optical storage medium;

Step S84: amplifying the detected RF waveform 61;

Step S86: selectively boosting the amplitudes of the sinewaves 64 with different boost gains according to the respective frequencies of the sinewaves 64 in the RF waveform 61 to obtain a corresponding gain boost signal 66;

Step S88: judging the gain boost signal 66 whether it is within a predetermined blank judgment interval;

Step S92: slicing the gain boost signal 66 according to the blank judgment interval on a predetermined level and detecting whether the gain boost signal has the amplitudes beyond the blank judgment interval, so as to determine whether the judgment signal 72 should be situated in the first judgment level 74 or the second judgment level 76;

Step S94: determining the RF is from the data recording regions or the blank regions according to whether that the judging signal 72 is situated in the first judging level 74 or the second judging level 76.

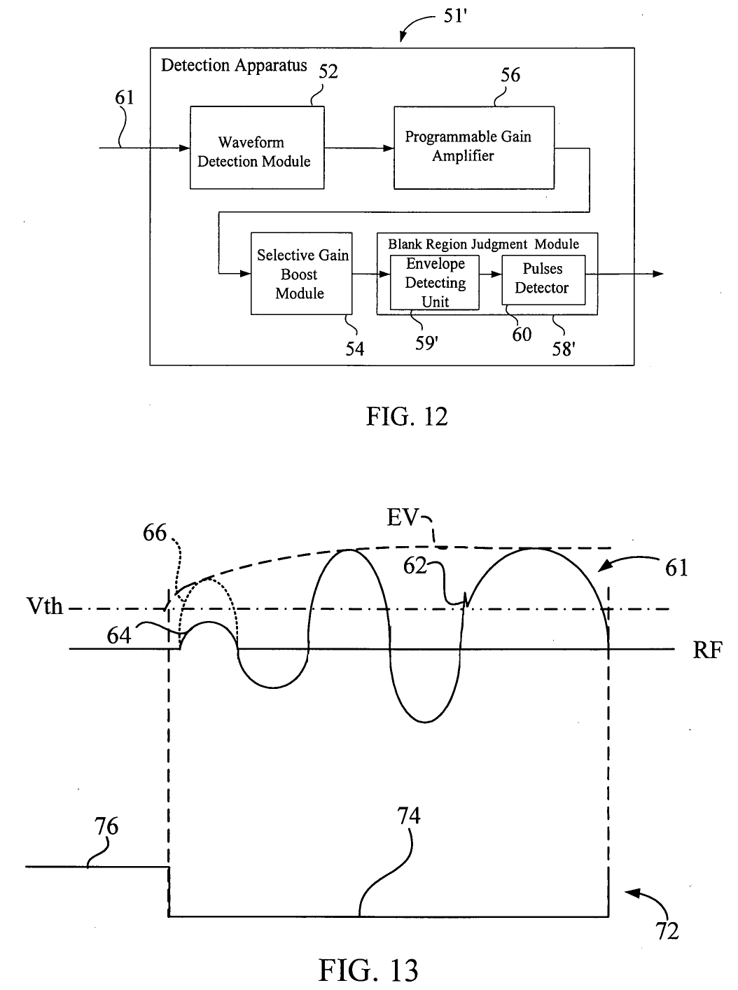

Referring to FIG. 12 and FIG. 13, FIG. 12 is a block diagram of a detection apparatus 51′ according to another preferred embodiment of the invention. FIG. 13 is a schematic diagram of the signals when the detection apparatus 51′ utilizing a predetermined threshold Vth to detect blank regions. In this embodiment, the detection apparatus 51′ is also used for detecting blank regions on an optical storage medium.

The detection apparatus 51′ comprises a waveform detection module 52, a programmable gain amplifier 56, a selective gain boost module 54, and a blank region judgment module 58′, wherein the functions of the waveform detection module 52, the programmable gain amplifier 56, and the selective gain boost module 54 are the same as those of the aforesaid detection apparatus 51.

As shown in FIG. 13, the main difference between the detection apparatus 51 shown in FIG. 8 and the detection apparatus 51′ shown in FIG. 12 is that the blank region judgment module 58′ is used for judging an envelope EV of the gain boost signal 66 with a predetermined threshold Vth. In this embodiment, The selective gain boost module 54 will boost the amplitude of the input sinewave 64 of the RF waveform 61 which has higher frequency over the predetermined threshold Vth. When the RF waveform 61 is detected from the data recording region, the RF waveform 61 comprises background noises 62 and a plurality of different frequency sinewaves 64. When the RF waveform 61 is detected from the blank regions, the RF waveform 61 comprises only background noises 62 but no sinewaves 64.

As shown in FIG. 12, the blank region judgment module 58′ comprises an envelope detecting unit 59′ and a pulses detector 60. The envelope detecting unit 59′ is used for detecting the envelope EV of the gain boost signal 66, and comparing the envelope EV of the gain boost signal 66 with the predetermined threshold Vth, so as to determine whether the judgment signal 72 shown in FIG. 13 is situated in the first or the second judgment level. The pulses detector 60 will determine whether the judgment signal 72 should be situated in the first judgment level 74 or the second judgment level 76 by the result of the envelope detecting unit 59′, and then determine whether the RF waveform 61 detected by the waveform detection module 52 is from the data recording regions or the blank regions.

When the envelope EV of the gain boost signal 66 is not beyond the predetermined threshold Vth, the judgment signal 72 should be situated in the second judgment level 76, and the RF waveform detected by the waveform detection module is deemed from the blank regions, otherwise the judgment signal 72 should be situated in the first judgment level 74, and the RF waveform detected by the waveform detection module is deemed from the data recording regions.

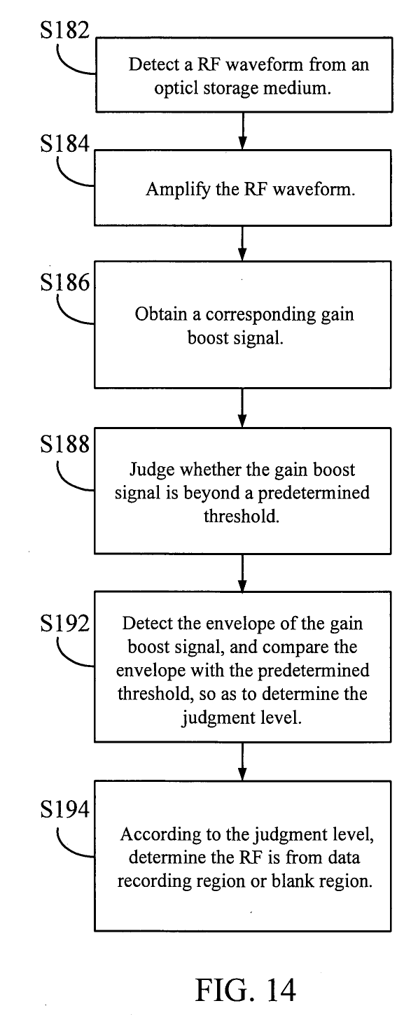

Referring to FIG. 14, FIG. 14 is a flowchart of the detecting method according to the invention. The detecting method of the invention comprises the following steps:

Step S182: detecting the RF waveform 61 from the optical storage medium;

Step S184: amplifying the detected RF waveform 61;

Step S186: selectively boosting the amplitudes of the sinewaves 64 with different boost gains according to the respective frequencies of the sinewaves 64 in the RF waveform 61 to obtain a corresponding gain boost signal 66;

Step S188: judging whether the gain boost signal 66 is beyond a predetermined threshold Vth;

Step S192: detecting the envelope EV of the gain boost signal 66, and comparing the envelope EV of the gain boost signal 66 with the predetermined threshold Vth, so as to determine whether the judgment signal should be situated in the first judgment level 74 or the second judgment level 76;

Step S194: determining whether the RF signal is from the data recording regions or the blank regions according to whether that the judging signal 72 is situated in the first judging level 74 or the second judging level 76.

Therefore, the invention provides a detection apparatus 51 and a detecting method for detecting blank regions which have not yet recorded data on an optical storage medium. The detecting method is to detect an RF waveform 61 from the optical storage medium, wherein the RF waveform 61 comprises a plurality of different frequency sinewaves 64, and then to selectively boost the amplitude of sinewaves 64 by different boost gain according to the different frequency of sinewave 64 of the RF waveform 61 to obtain a corresponding gain boost signal 66, and further to judge the gain boost signal with a predetermined blank judgment interval or a predetermined threshold. When the amplitude of the gain boost signal is within the blank judgment interval or not beyond the predetermined threshold, it means the RF signal detected by the waveform detection module 52 is from the blank regions. Whereby, the method of the invention can more precisely detect the blank regions which have not yet recorded data thereon of the optical storage medium.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A detection apparatus for detecting blank regions of an optical storage medium containing data recording regions and blank regions, the data recording regions being regions in the optical storage medium, which have recorded a plurality of data thereon, and the blank regions being regions in the optical storage medium, which have not yet recorded data thereon, the detection apparatus comprising:
a waveform detection module for detecting a radio frequency (RF) waveform from the optical storage medium, the RF waveform substantially comprising background noises and a plurality of different frequency sinewaves, wherein the higher the frequency sinewave is, the smaller the amplitude is;
a selective gain boost module for selectively boosting the amplitudes of the sinewaves with different boost gains according to the respective frequencies of the input sinewaves in the RF waveform, and obtaining a corresponding gain boost signal; and
a blank region judgment module for judging the gain boost signal with a predetermined blank judgment interval, wherein when the present amplitudes of the gain boost signal fall within the blank judgment interval, the RF waveform detected by the waveform detection module is deemed from the blank regions, otherwise the RF waveform detected by the waveform detection module is deemed from the data recording regions.

2. The detection apparatus of claim 1, applied in an optical recording/reproducing apparatus, wherein the optical recording/reproducing apparatus further comprises a variable gain amplifier (VGA), an auto gain controller (AGC) coupled to the VGA, a filter, and an analog-to-digital converter for processing RF data from the optical storage medium.

3. The detection apparatus of claim 1, wherein the upper and lower limits of the blank judgment interval are defined by a positive hysteresis level (PHL) and a negative hysteresis level (NHL).

4. The detection apparatus of claim 3, wherein the selective gain boost module boosts the amplitudes of the input sinewaves which have higher frequencies over the PHL and the NHL.

5. The detection apparatus of claim 1, wherein when the RF waveform is detected from the data recording regions, the RF waveform comprises background noises and different frequency sinewaves, and when the RF waveform is detected from the blank regions, the RF waveform comprises only background noises but no frequency sinewaves.

6. The detection apparatus of claim 1, wherein the detection apparatus further comprises a programmable gain amplifier for amplifying the RF waveform detected by the waveform detection module, and then outputting to the selective gain boost module.

7. The detection apparatus of claim 1, wherein the blank region judgment module generates a corresponding judgment signal comprising a first judgment level and a second judgment level, when the amplitudes of the gain boost signal is beyond the blank judgment interval, the judgment signal is situated in the first judgment level, otherwise the judgment signal is situated in the second judgment level.

8. The detection apparatus of claim 7, wherein the blank region judgment module comprises:
a slicing comparator, for setting the blank judgment interval on a predetermined level, slicing the gain boost signal, and detecting whether the gain boost signal has the amplitudes beyond the blank judgment interval, so as to determine whether the judgment signal is situated in the first or the second judgment level; and
a pulses detector, for determining whether the RF waveform detected by the waveform detection module is from the data recording regions or the blank regions according to whether the judgment signal is situated in the first or the second judgment level.

9. The detection apparatus of claim 1, wherein the gain of the selective gain boost module is substantially from 0 dB to 13 dB.

10. A detection method for detecting blank regions of an optical storage medium containing data recording regions and blank regions, the data recording regions being regions in the optical storage medium which have recorded a plurality of data thereon, and the blank regions being regions in the optical storage medium, which have not yet recorded data thereon, the detection method comprising the following steps:
(A) detecting a radio frequency (RF) waveform from the optical storage medium, the RF waveform potentially comprising background noises and a plurality of different frequency sinewaves, wherein the higher the frequency sinewave is, the smaller the amplitude is;
(B) selectively boosting the amplitudes of the sinewaves with different boost gains according to the respective frequencies of the input sinewaves in the RF waveform, and obtaining a corresponding gain boost signal; and
(C) judging the gain boost signal with a predetermined blank judgment interval, wherein when the present amplitudes of the gain boost signal fall within the blank judgment interval, the RF waveform is deemed detected from the blank regions, otherwise the RF waveform is deemed detected from the data recording regions.

11. The detection method of claim 10, wherein the upper and lower limits of the blank judgment interval are defined by a positive hysteresis level (PHL) and a negative hysteresis level (NHL).

12. The detection method of claim 11, wherein the detection method further boosts the amplitudes of the input sinewaves which have higher frequencies over the PHL and the NHL.

13. The detection method of claim 10, wherein when the RF waveform is detected from the data recording regions, the RF waveform comprises background noises and different frequency sinewaves, and when the RF waveform is detected from the blank regions, the RF waveform comprises only background noises but no frequency sinewaves.

14. The detection method of claim 10, wherein, before step (B), a programmable gain amplifier is further utilized for amplifying the detected RF waveform.

15. The detection method of claim 10, wherein in step (C), a corresponding judgment signal, comprising a first judgment level and a second judgment level, is further generated, and wherein when the amplitudes of the gain boost signal is beyond the blank judgment interval, the judgment signal is situated in the first judgment level, otherwise the judgment signal is situated in the second judgment level.

16. The detection method of claim 15, wherein step (C) further comprises the following steps:
setting the blank judgment interval on a predetermined level, slicing the gain boost signal, and detecting whether the gain boost signal has the amplitudes beyond the blank judgment interval, so as to determine whether the judgment signal is situated in the first or the second judgment level; and
determining whether the RF waveform is detected from the data recording regions or the blank regions according to whether the judgment signal is situated in the first or the second judgment level.

17. The detection method of claim 10, wherein the gain in step (B) is substantially from 0 dB to 13 dB.

18. A detection apparatus for detecting blank regions of an optical storage medium containing data recording regions and blank regions, the data recording regions being regions in the optical storage medium, which have recorded a plurality of data thereon, and the blank regions being regions in the optical storage medium, which have not yet recorded data thereon, the detection apparatus comprising:
a waveform detection module for detecting a radio frequency (RF) waveform from the optical storage medium, the RF waveform potentially comprising background noises and a plurality of different frequency sinewaves, wherein the higher the frequency sinewave is, the smaller the amplitude is;
a selective gain boost module for selectively boosting the amplitudes of the sinewaves with different boost gains according to the respective frequencies of the input sinewaves in the RF waveforms, and obtaining a corresponding gain boost signal; and
a blank region judgment module for judging an envelope of the gain boost signal with a predetermined threshold, wherein when the envelope of the gain boost signal is not beyond the predetermined threshold, the RF waveform detected by the waveform detection module is deemed from the blank regions, otherwise the RF waveform detected by the waveform detection module is deemed from the data recording regions.

19. The detection apparatus of claim 18, applied in an optical recording/reproducing apparatus, wherein the optical recording/reproducing apparatus further comprises a variable gain amplifier (VGA), an auto gain controller (AGC) coupled to the VGA, a filter, and an analog-to-digital converter for processing RF data from the optical storage medium.

20. The detection apparatus of claim 18, wherein the selective gain boost module boosts the amplitudes of the input sinewaves which have higher frequencies over the predetermined threshold.

21. The detection apparatus of claim 18, wherein when the RF waveform is detected from the data recording regions, the RF waveform comprises background noises and different frequency sinewaves, and when the RF waveform is detected from the blank regions, the RF waveform comprises only background noises but no frequency sinewaves.

22. The detection apparatus of claim 18, wherein the detection apparatus further comprises a programmable gain amplifier for amplifying the RF waveform detected by the waveform detection module, and then outputting to the selective gain boost module.

23. The detection apparatus of claim 18, wherein the blank region judgment module generates a corresponding judgment signal comprising a first judgment level and a second judgment level, when the amplitudes of the gain boost signal is beyond the predetermined threshold, the judgment signal is situated in the first judgment level, otherwise the judgment signal is situated in the second judgment level.

24. The detection apparatus of claim 23, wherein the blank region judgment module comprises:
an envelope detecting unit, for detecting the envelope of the gain boost signal, and comparing the envelope of the gain boost signal with the predetermined threshold, so as to determine whether the judgment signal is situated in the first or the second judgment level; and
a pulses detector, for determining whether the RF waveform detected by the waveform detection module is from the data recording regions or the blank regions according to whether the judgment signal is situated in the first or the second judgment level.

25. The detection apparatus of claim 18, wherein the gain of the selective gain boost module is substantially from 0 dB to 13 dB.

26. A detection method for detecting blank regions of an optical storage medium containing data recording regions and blank regions, the data recording regions being regions in the optical storage medium which have recorded a plurality of data thereon, and the blank regions being regions in the optical storage medium, which have not yet recorded data thereon, the detection method comprising the following steps:
(A) detecting a radio frequency (RF) waveform from the optical storage medium, the RF waveform potentially comprising background noises and a plurality of different frequency sinewaves, wherein the higher the frequency sinewave is, the smaller the amplitude is;
(B) selectively boosting the amplitudes of the sinewaves with different boost gains according to the respective frequencies of the input sinewaves in the RF waveform, and obtaining a corresponding gain boost signal; and
(C) judging an envelope of the gain boost signal with a predetermined threshold, wherein when the envelope of the gain boost signal is not beyond the predetermined threshold, the RF waveform is deemed from the blank regions, otherwise the RF waveform is deemed from the data recording regions.

27. The detection method of claim 26, wherein the detection method further boosts the amplitudes of the input sinewaves which have higher frequencies over the predetermined threshold.

28. The detection method of claim 26, wherein when the RF waveform is detected from the data recording regions, the RF waveform comprises background noises and different frequency sinewaves, and when the RF waveform is detected from the blank regions, the RF waveform comprises only background noises but no frequency sinewaves.

29. The detection method of claim 26, wherein, before step (B), a programmable gain amplifier is further utilized for amplifying the detected RF waveform.

30. The detection method of claim 26, wherein in step (C), a corresponding judgment signal, comprising a first judgment level and a second judgment level, is further generated, and wherein when the amplitudes of the gain boost signal is beyond the predetermined threshold, the judgment signal is situated in the first judgment level, otherwise the judgment signal is situated in the second judgment level.

31. The detection method of claim 30, wherein step (C) further comprises the following steps:
detecting the envelope of the gain boost signal, and comparing the envelope of the gain boost signal with the predetermined threshold, so as to determine whether the judgment signal is situated in the first or the second judgment level; and
determining whether the RF waveform is detected from the data recording regions or the blank regions according to whether the judgment signal is situated in the first or the second judgment level.

32. The detection method of claim 26, wherein the gain in step (B) is substantially from 0 dB to 13 dB.
